(19) United States
(12) Patent Application Publication
(10) Pub. No.: US 2026/0129573 A1
(43) Pub. Date: May 7, 2026

(54) METHODS AND SYSTEMS FOR NETWORK ENERGY REDUCTION

(71) Applicant: T-Mobile Innovations LLC, Overland Park, KS (US)

(72) Inventor: Jasinder P. SINGH, Olathe, KS (US)

(21) Appl. No.: 18/940,004

(22) Filed: Nov. 7, 2024

(51) Int. Cl. H04W 52/02

(52) U.S. Cl. CPC H04W 52/0206

(57) ABSTRACT

Systems, methods and devices are provided for disabling at least one radio access network (RAN) cell of a group of active RAN cells to reduce energy and in response to disabling at least one active RAN cell, modifying a waveform or power of wireless RF signals used for communication between a wireless device and at least one of the remaining active RAN cells.

### TECHNICAL BACKGROUND

Components of a wireless network, such as radio access network (RAN) cells, consume vast amounts of electricity, even when utilization of those components is lower, such as during times of the day when data traffic is lower. Often those components need to stay on even during low utilization to maintain service quality for the connected devices utilizing the system.

### OVERVIEW

Exemplary embodiments described herein include systems, methods, and processing nodes for network energy reduction. An exemplary method includes disabling at least one radio access network (RAN) cell of a group of active RAN cells to reduce energy and, in response to disabling at least one active RAN cell, modifying a waveform or power of wireless radio frequency (RF) signals used for communication between a wireless device and at least one of the remaining active RAN cells.

Further exemplary embodiments include a system for network energy reduction. The system includes a group of RAN cells and a computing device communicatively connected to the plurality of RAN cells, the computing device configured to disable at least one RAN cell of the group of active RAN cells and, in response to disabling at least once active RAN cell, modify a waveform or power of wireless RF signals used for communication between a wireless device and at least one of the remaining active RAN cells.

In yet a further exemplary embodiment, a non-transitory computer readable medium is provided. The non-transitory computer-readable medium stores instructions, when executed by a processor, configuring the processor to disable at least one RAN cell of a group of RAN cells to reduce energy and, in response to disabling at least one active RAN cell, modify a waveform or power of wireless RF signals used for communication between a wireless device and at least one of the remaining active RAN cells.

### BRIEF DESCRIPTION OF THE DRAWINGS

FIG. 1 illustrates an exemplary system for network transmission management in accordance with disclosed embodiments.

FIG. 2 illustrates an exemplary method for network energy reduction in accordance with disclosed embodiments.

FIG. 3 illustrates an exemplary method for network energy reduction in accordance with disclosed embodiments.

FIG. 4 illustrates an exemplary method for network energy reduction in accordance with disclosed embodiments.

FIG. 5 illustrates an exemplary method for network energy reduction in accordance with disclosed embodiments.

FIG. 6 illustrates an example of a processing node in accordance with aspects of this disclosure.

FIG. 7 illustrates an example of a computing device in accordance with aspects of this disclosure.

### DETAILED DESCRIPTION

During times when utilization of the network is lower, reducing usage of some components of a network can save energy that would otherwise be wasted. However, turning off some of those components will negatively affect the service being provided to devices utilizing the network. For example, turning off RAN cells of the network may increase the signal-to-Interference-plus-noise ratio (SINR) and reduce coverage due to the increased noise floor for the remaining active RAN cells.

As modern 5G networks enable dynamic changes to waveform and power class for devices connected to the network, the network may be able to maintain quality of service to connected devices when turning off components by modifying these parameters.

Exemplary embodiments described herein include methods and systems for reducing energy consumption by a network by disabling at least one RAN cell and based on that disabling the at least one cell, modifying a waveform or power for the remaining active RAN cells. For example, the network may modify the waveform for the remaining active RAN cells to a waveform that is less energy intensive. In instances, the network may allocate a portion of the capacity of the disabled RAN cell to active cells by increasing the energy output to active cells.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

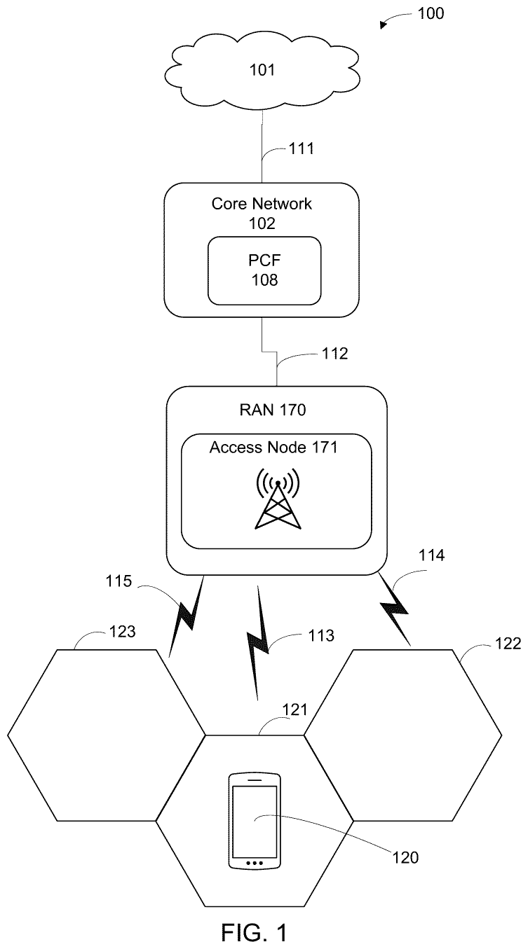

These and other examples will be described in greater detail below in relation to FIGS. 1-7.

FIG. 1 depicts an exemplary system 100 for network energy reduction. System 100 includes a communication network 101, a core network 102 and a radio access network (RAN) 170, including at least one access node 171. Core network 102 is connected to communication network 101 over communication link 111.

System 100 also includes a wireless device 120. In embodiments, system 100 may include multiple wireless devices. Wireless device 120 is configured to operate in one or more cells 121, 122, and 123. Wireless device 120 may be an end-user wireless device. Wireless device 120 may include any device configured to send and receive messages over SIP. Wireless device 120 may include any device configured to send and receive VoIP calls, such as voice over LTE (VoLTE) and voice over new radio (VoRN) calls. In embodiments, wireless device 120 using cells 121, 122, and 123 communicate with RAN 170 over communication links 113, 114 and 115 respectively. Examples of communication links 113, 114 and 115 may include a 6G network link, 5G network link, 4G LTE network link, and the like.

The RAN 170 includes at least one access node (or base station) 171. Multiple access nodes may be utilized. In embodiments, the at least one access node 171 may include an evolved Node B (eNodeB) or a next generation Node B (gNodeB) communicating with the plurality of end-user wireless devices 120. Access node 171 generates one or more cells 121, 122, and 123 of geographical cellular coverage. In embodiments, access node 171 generates a group of active RAN cells comprising cells 121, 122, and 123.

Access node 171 can be, for example, standard access nodes such as a macro-cell access node, a base transceiver station, a radio base station, an enhanced eNodeB device, or the like. In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for network component energy reduction may be included within the access nodes. Access node 171 can be configured to deploy one or more different carriers, utilizing one or more RATs. It would be evident to one of ordinary skill in the art, in light of this disclosure, the many other combinations of access nodes and carriers that could be deployed.

Access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The RAN 170 may include other devices and additional nodes not described herein. For example, RAN 170 may include devices used for routing data from wireless device 120 to core network 102. RAN 170 is connected to core network 102 over communication link 112.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile network or wireless system (5G, 5G New Radio (“5G NR”), or 5G LTE), 6G, other terrestrial network protocols, and/or non-terrestrial network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or other protocols. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions.

Although one core network 102 is shown, multiple core networks 102 may be utilized. Alternatively, the single core network 102 may include a distributed, cloud-native, converged core gateway.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

It is understood that the disclosed technology may also be applied to communication between an end-user wireless device and other network resources, such as relay nodes, controller nodes, and antennas.

The wireless devices 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a VoIP phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network energy reduction may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

With continued reference to FIG. 1, an exemplary embodiment is shown. Core 102 includes a policy control function (PCF) 108. PCF 108, as used herein, includes policies and parameters for adjusting waveform, power output, and/or power class for remaining active cells 121, 122, and 123 of a group of RAN cells and/or wireless device 120. PCF 208 may transmit waveform, power output, and/or power class configuration parameters to access node 171. In this example, access node 171 then implements the configuration parameters for one or more of cells 121, 122, and 123 and in embodiments, relays the configuration changes to wireless device 120.

In an example, wireless device 120 transmits an initial attach request to communication network 101 which includes an RRC connection request. For example, access node 171 a default connection may be cyclic prefix orthogonal frequency division multiplexing (CP-OFDM) waveform and a power class 2 mode (PC2) for the wireless device 120. Once attached, wireless device 120 may transmit data to, and receive data from, the recipient component using communication network 101. In an example, the selection of power class and waveform for access node 171 may be performed using input from the PCF 108.

In embodiments, access node 171 may be configured to modify power output, power class, and/or waveform for communication between wireless devices and with cells 121, 122, and 123. In various embodiments, the modification of power output, power class and/or waveform includes the modification of waveform or power output of downlink wireless RF signals that are transmitted by the cells, or modifications of waveform and power class of uplink wireless RF signals that are received by the cells. In an embodiment, access node 171 may modify waveform, power output, and/or power class of one or more active cells 121, 122, and 123 and wireless device 120 using parameters and policies set by PCF 208. For example, access node 171 may make changes to waveform and/or power class of one or more active cells 121, 122, and 123 and/or wireless device 120 based on a set schedule. For example, changes to waveform, power output, and/or power class may be made during certain times of the day when one or more cells are disabled. In another example, access node 171 may modify waveform, power output, and/or power class of one or more active cells and/or wireless device 120 based on overall network traffic for the connected to the wireless device 120 when one or more cells are disabled.

In an example, access node 171 may modify the waveform for wireless device 120 from the assigned CP-OFDM, to a discrete Fourier transform spread OFDM (DFT-s-OFDM), which may be less energy resource intensive. In some embodiments, the change in waveform may be for the uplink waveform. In some embodiments, the change in waveform may be for both uplink and/or downlink. For example, if cell 121 has been disabled for energy savings, wireless network 270 may modify the uplink waveform from CP-OFDM to DFT-s-OFDM for cells 122 and 123 with respect to wireless devices that are attached to the cells 122 and 123 by sending corresponding modification instructions to the wireless devices, while maintaining the CP-OFDM, assigned at attachment, for the downlink waveform of the wireless downlink RF signals to the wireless devices. Change the uplink waveform to DFT-s-OFDM helps gain the coverage lost and reduce SINR when one or more cells of a RAN group are disabled.

In an example, wireless network access node 171 may modify the power class for wireless device 120 from a default PC2 for cells 122 and 123 and to a power class 3 mode (PC3) by sending corresponding modification instructions to the wireless device 120 when cell 121 has been disabled for power savings. Wireless device 120 uses the reduced PC3 even if wireless device 120 is capable of PC2 to reduced SINR, particularly for uplink transmissions.

In another example, to reduce downlink SINR when one or more cells of a RAN group of cells have been disabled, if the disabled cell and active cell are on the same access node 171, some of power previously used for the disabled cell can be assigned to an active cell.

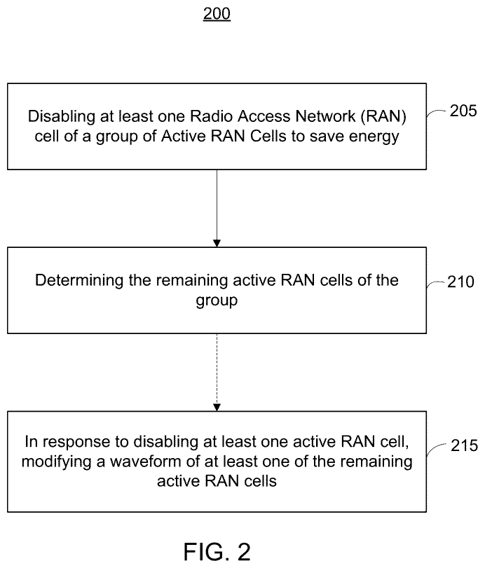

With reference to FIG. 2, a flow diagram of method 200 for network energy reduction is presented. Method 200 includes, at step 205, disabling at least one RAN cell of a group of active RAN cells to reduce energy. As described in reference to FIG. 1, the at least one RAN cell may be disabled based on a set energy reduction policy. For example, the at least one RAN cells may be disabled based on a policy for energy reduction during specific times of the day. In another example, the policy may include reducing energy by disabling at least one RAN cell based on the network traffic going through an access node. At step 210, the remaining active RAN cells from the group of RAN cells is determined.

At step 215, method 200 includes, in response to disabling at least one active RAN cell, modifying a waveform of at least one of the remaining active RAN cells. In embodiments, modifying the waveform includes modifying the waveform of downlink wireless RF signals transmitted by the at least one of the remaining active RAN cells to the wireless device. For example, modifying the waveform may include changing from CP-OFDM to a DFT-s-OFDM for at least one of the remaining active cells.

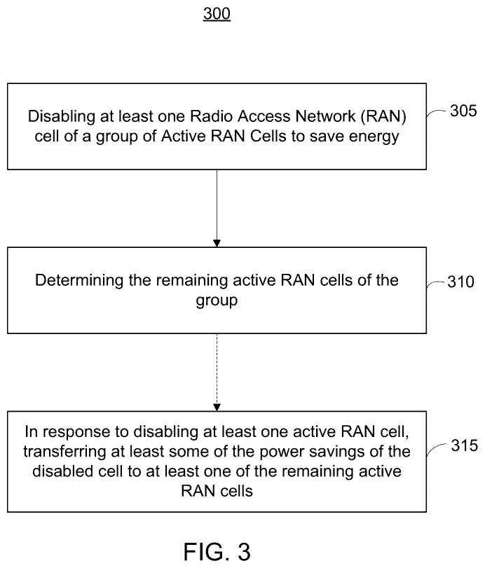

Now referring to FIG. 3, a flow diagram of method 300 for network energy reduction is presented. Method 300 includes, at step 305, disabling at least one RAN cell of a group of active RAN cells to reduce energy. As described in reference to FIG. 1, the at least one RAN cell may be disabled based on a set energy reduction policy. For example, the at least one RAN cells may be disabled based on a policy for energy reduction during specific times of the day. In another example, the policy may include reducing energy by disabling at least one RAN cell based on the network traffic going through an access node. At step 310, the remaining active RAN cells from the group of RAN cells is determined.

At step 315 of FIG. 3, power output of downlink wireless RF signals transmitted by the at least one of the remaining active RAN cells is increased by transferring some of the power savings from the disabled cell. For example, the energy increase to the at least one remaining active RAN cell may be equal to half of the energy capacity of the at least one disabled RAN cell. For example, the power output to the active RAN cells may be equal to half of the energy capacity of the disabled cell(s). For example, if a disabled RAN cell has a 2 W/MHz capacity, an active RAN cell may receive an energy output of 1 W/MHz.

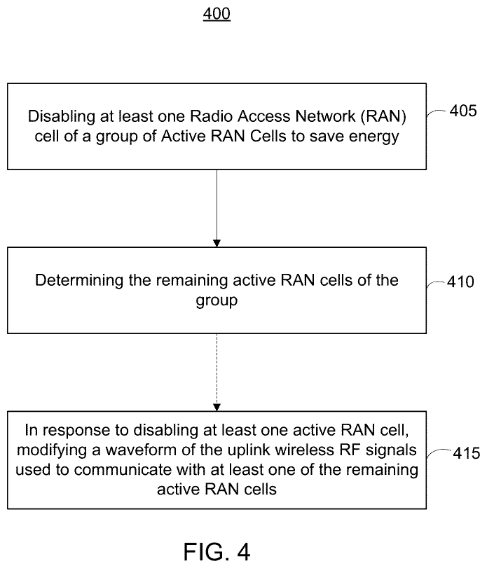

Now referring to FIG. 4, a flow diagram of method 400 for network energy reduction is presented. Method 400 includes, at step 405, disabling at least one RAN cell of a group of active RAN cells to reduce energy. As described in reference to FIG. 1, the at least one RAN cell may be disabled based on a set energy reduction policy. For example, the at least one RAN cells may be disabled based on a policy for energy reduction during specific times of the day. In another example, the policy may include reducing energy by disabling at least one RAN cell based on the network traffic going through an access node.

At step 410, the remaining active RAN cells from the group of RAN cells is determined. At step 415, method 400 includes, in response to disabling at least one active RAN cell, modifying a waveform of the uplink wireless RF signals used to communicate with at least one of the remaining active RAN cells. In embodiments, modifying the waveform includes modifying the waveform of the uplink wireless RF signals which a wireless device transmits to an active RAN cell. For example, modifying the waveform may include changing from CP-OFDM to a DFT-s-OFDM for at least one of the remaining active cells.

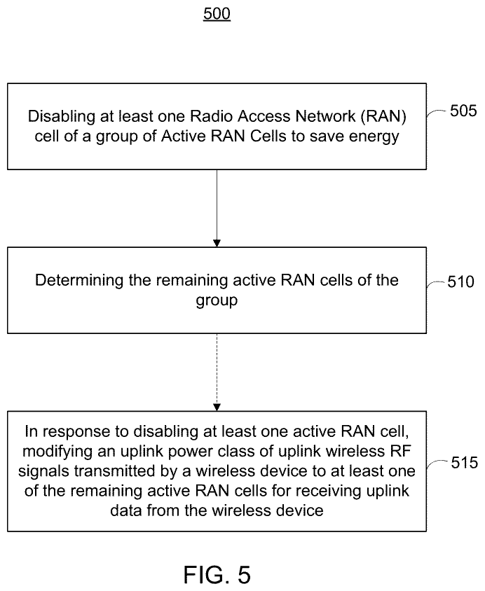

With reference to FIG. 5, a flow diagram of method 5200 for network energy reduction is presented. Method 500 includes, at step 505, disabling at least one RAN cell of a group of active RAN cells to reduce energy. As described in reference to FIG. 1, the at least one RAN cell may be disabled based on a set energy reduction policy. For example, the at least one RAN cells may be disabled based on a policy for energy reduction during specific times of the day. In another example, the policy may include reducing energy by disabling at least one RAN cell based on the network traffic going through an access node. At step 510, the remaining active RAN cells from the group of RAN cells is determined.

At step 515 of FIG. 5, method 500 includes modifying an uplink power class of uplink wireless RF signals transmitted by a wireless device to at least one of the remaining active RAN cells for receiving uplink data from the wireless device. For example, the uplink power class for the wireless device may be modified from power class 2 mode (PC2) to power class 3 mode (PC3).

In some embodiments, any combinations of methods 200, 300, 400 and 500 may be employed to improve SINR when one or more RAN cells are disabled. In embodiments, methods 200, 300, 400 and 500 may include modifying the waveform or power output of wireless RF signals transmitted by at the least one of the remaining active RAN cells based on configuration parameters. For example, modifying the waveform or power may be based on configuration parameters transmitted by PCF. The PCF may be the same as PCF 108 described in reference to FIG. 1.

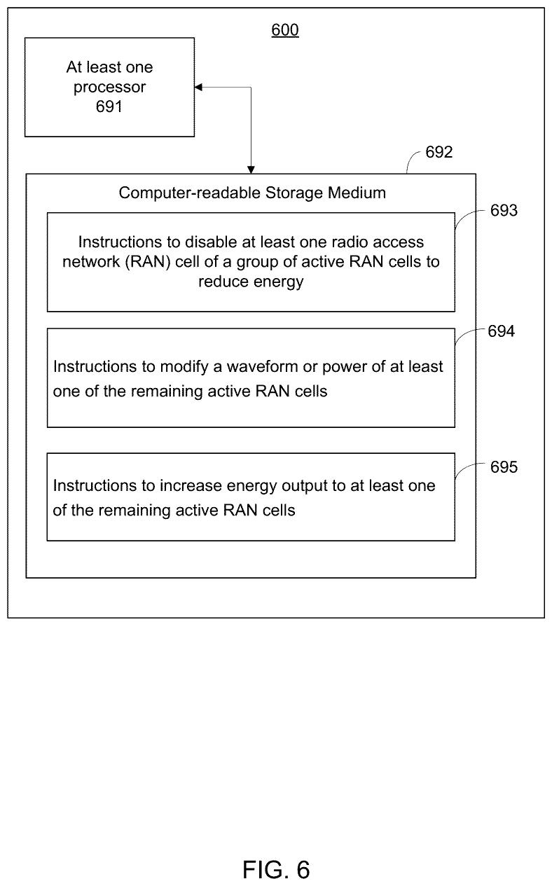

Now referring to FIG. 6, an example computing device 600 is presented. In embodiments, computing device 500 may include a node device, such as devices operating within communication network described in reference to FIG. 1. In this example, computing device 600 includes at least one processor 691 communicably coupled to a computer-readable storage medium 692. The at least one processor 691 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 692. In instances, at least one processor 691 may include electronic circuitry for performing instructions described in this disclosure.

In instances, computer-readable storage medium 692 may be any medium suitable for storing executable instructions. In examples, without limitation, computer-readable storage medium 692 may include read-only memory (ROM), random-access memory (RAM), erasable electrically programmable ROM (EEPROM), Solid State Drive (SSD), optical disc, and the like. Computer-readable medium storage 692 may be disposed within computing device 600. In embodiments, computer-readable storage medium 692 may be external, and communicably connected, to computing device 600. The instruction stored on computer-readable storage medium may be used to implement method steps described in reference to FIGS. 2, 3, 4 and 5.

In this example, computer-readable storage medium 692 is encoded with a set of instructions 693 and 694. In some embodiments, computer-readable storage medium 692 may further be encoded with instruction 695 and/or other sets of instructions. In embodiments, executable instructions included in each block may be included in different blocks shown and blocks not shown.

Instruction 693, when executed by at least one processor 691, configures the at least one processor 691 to disable at least one radio access network (RAN) cell of a group of active RAN cells to reduce energy.

Instruction 694, when executed by at least one processor 691, configures the at least one processor 691 to modify a waveform or power of at least one of the remaining active RAN cells.

In embodiments, computer-readable storage medium 692 may include instruction 695 configuring the at least one processor 691 to increase energy output to at least one of the remaining active RAN cells. In embodiments, computer-readable storage medium 692 may include instruction 697 configuring the at least one processor 691 to transmit the authentication response to a call center.

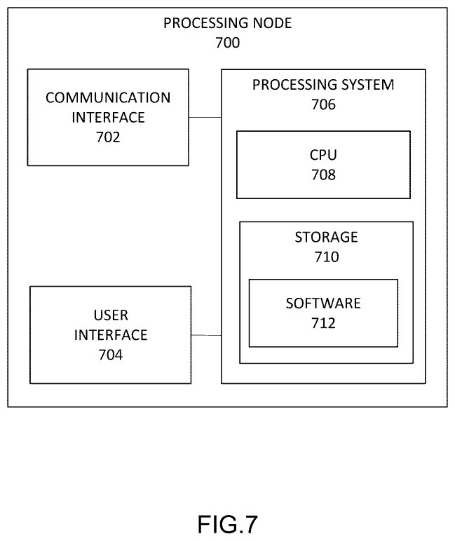

Now referring to FIG. 7, an example processing node 700, which may be configured to perform the methods and operations disclosed herein for network energy reduction. The processing node 700 includes a communication interface 702, user interface 704, and processing system 706 in communication with communication interface 702 and user interface 704. Communication interface 702 may include hardware components, such as network communication ports, devices, routers, wires, antenna, transceivers, etc. User interface 704 may include hardware components, such as touch screens, buttons, displays, speakers, etc.

Processing system 706 includes a central processing unit (CPU) or processor 708 and storage 710. Storage 710 may include a disk drive, flash drive, memory circuitry, or other memory device including, for example, a buffer. Storage 710 can store software 712 which is used in the operation of the processing node 700. Software 712 may include computer programs, firmware, or some other form of machine-readable instructions, including an operating system, utilities, drivers, network interfaces, applications, or some other type of software. Processing system 706 may include a processor 708 and other circuitry to retrieve and execute software 712 from storage 710, which may be internal or external to the processing system 706. Processing node 700 may further include other components such as a power management unit, a control interface unit, etc., which are omitted for clarity. Communication interface 702 permits processing node 700 to communicate with other network elements. User interface 704 permits the configuration and control of the operation of processing node 700. Processing node 700 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 712 may include the instructions described in reference to FIG. 6.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
disabling at least one radio access network (RAN) cell of a group of active RAN cells to reduce energy; and
in response to disabling at least one active RAN cell, modifying a waveform or power of wireless radio frequency (RF) signals used for communication between a wireless device and at least one of the remaining active RAN cells.

2. The method of claim 1, wherein modifying the power comprises modifying an uplink power class of uplink wireless RF signals transmitted by the wireless device to at least one of the remaining active RAN cells for receiving uplink data from the wireless device.

3. The method of claim 2, wherein modifying the uplink power class comprises changing from power class 2 mode (PC2) to power class 3 mode (PC3) for at least one of the remaining active RAN cells to receive uplink data from the wireless device.

4. The method of claim 1, wherein modifying the waveform of wireless RF signals comprises changing from a cyclic prefix orthogonal frequency division multiplexing (CP-OFDM) to a discrete Fourier transform spread OFDM (DFT-s-OFDM).

5. The method of claim 1, further comprising increasing energy output for downlink wireless RF signals of at least one of the remaining active RAN cells.

6. The method of claim 5, wherein the energy increase to the downlink RF signals of at least one remaining active RAN cell is equal to half of an energy capacity of the at least one disabled RAN cell.

7. The method of claim 1, wherein modifying the waveform or power of wireless RF signals for communication between the wireless device and at the least one of the remaining active RAN cells is based on configuration parameters.

8. The method of claim 7, wherein the configuration parameters are set by a policy control function (PCF).

9. A system, the system comprising:
a group of active radio access network (RAN) cells; and
a computing device communicatively connected to the group of active RAN cells, the computing device configured to:
disable at least one RAN cell of the group of active RAN cells; and
in response to disabling at least one active RAN cell, modify a waveform or power of wireless radio frequency (RF) signals used for communication between a wireless device and at least one of the remaining active RAN cells.

10. The system of claim 9, wherein modifying the power comprises modifying an uplink power class of at least one of the remaining active RAN cells for receiving uplink data from the wireless device.

11. The system of claim 10, wherein modifying the uplink power class comprises changing from power class 2 mode (PC2) to power class 3 mode (PC3) for at least one of the remaining active RAN cells to receive uplink data from the wireless device.

12. The system of claim 9, wherein modifying the waveform of wireless RF signals comprises changing from a cyclic prefix orthogonal frequency division multiplexing (CP-OFDM) to a discrete Fourier transform spread OFDM (DFT-s-OFDM).

13. The system of claim 9, wherein the computing device is further configured to increase energy output for downlink wireless RF signals of at least one the remaining active RAN cells.

14. The system of claim 13, wherein the energy increase to the at least one remaining active RAN cell is equal to half of energy capacity of the at least one disabled RAN cell.

15. The system of claim 9, wherein modifying the waveform or power of wireless RF signals for communication between the wireless device and at the least one of the remaining active RAN cells is based on configuration parameters.

16. A non-transitory computer-readable medium storing instructions, when executed by at least one processor, configuring the at least one processor to:
disable at least one radio access network (RAN) cell of a group of active RAN cells to reduce energy; and
in response to disabling at least one active RAN cell, modify a waveform or power of wireless radio frequency (RF) signals used for communication between a wireless device and at least one of the remaining active RAN cells.

17. The non-transitory computer-readable medium storing instructions of claim 16, wherein modifying the waveform of wireless RF signals comprises changing from a cyclic prefix orthogonal frequency division multiplexing (CP-OFDM) to a discrete Fourier transform spread OFDM (DFT-s-OFDM).

18. The non-transitory computer-readable medium storing instructions of claim 16, modifying the power comprises modifying an uplink power class of at least one of the remaining active RAN cells for receiving uplink data from a wireless device.

19. The non-transitory computer-readable medium storing instructions of claim 18, wherein modifying a power class of at least one of the remaining active RAN cells from power class 2 mode (PC2) to power class 3 mode (PC3) for receiving uplink data from the wireless device.

20. The non-transitory computer-readable medium storing instructions of claim 16, wherein modifying the waveform or power of wireless RF signals for communication between the wireless device and at the least one of the remaining active RAN cells is based on configuration parameters.
